(19) United States
(12) Patent Application Publication
(10) Pub. No.: US 2016/0096714 A1
(43) Pub. Date: Apr. 7, 2016

(54) Articulating Enclosed Lift Apparatus and a Method of Operating the Same

(71) Applicant: Batchelor & Kimball, Inc., Lithonia, GA (US)

(72) Inventors: Brian David Batchelor, Atlanta, GA (US); David Mayer Batchelor, Atlanta, GA (US); Charles Sanchez, Villa Rica, GA (US); Trent W. Strine, Grayson, GA (US); Charles McGowan, Elberton, GA (US)

(21) Appl. No.: 14/505,559

(22) Filed: Oct. 3, 2014

(51) Int. Cl. B66F 11/04; B66F 17/00

(52) U.S. Cl. CPC B66F 11/042; B66F 17/006

(57) ABSTRACT

A multi-articulating enclosed lift assembly is described having an adjustable work platform, a guardrail system on the platform, and a flexible enclosure. The work platform generally includes a base, a lift, and an operator platform supporting the guardrail system. The flexible enclosure includes an extendible frame and a flexible containment material. The material may be disposed proximate to sides of the extendible frame and sealed to the base of the adjustable work platform and along a top of the extendible frame. The flexible enclosure and the base define a working space below a ceiling as the top of the extendible frame engages an opening in the ceiling. As such, the lift selectively moves the operator platform within the working space to place it in a desired vertical position within the flexible enclosure and allow a configuration of at least a portion of the guardrail system to extend through the opening.

### DESCRIPTION OF THE INVENTION

1. Field of the Disclosure

The present disclosure relates to systems, apparatus and methods in the field of mobile enclosure units and, more particularly, to an articulating enclosed lift assembly that may provide a flexible and dynamically configurable mobile work enclosure and platform for an operator when conducting construction or repair work on or above a ceiling.

2. Background

Certain types of buildings typically require that the building maintain a minimum level of clean air. An occupied hospital, a clinic, a medical laboratory, and an industrial “clean room” are examples of these types of buildings or facilities within buildings. The on-going activities conducted within such a building or facility may require high-efficiency particulate air (conventionally known as “HEPA”) filtration or some other degree of strong air filtration in order to keep particles in the air from contaminating the occupants or products exposed to the air within the building or facility.

When construction is conducted within such a building or facility, the construction may result in debris and contaminant particles that may be detrimental to the on-going activities within the building or facility. Indeed, the construction may generate potentially hazardous dust, particles, or other debris. This can be especially problematic with a building's air handling system that may take such contaminant particles generated in the vicinity of the construction and further distribute the contaminant particles to other parts of the building or facility as air circulates through disparately located intakes and vents of the air handling system. Thus, there is often a need to contain debris and contaminant particles generated during construction within such a building or facility.

A conventional way to contain debris and contaminant particles generated during construction in such an air quality restricted building or facility involves an enclosure from a floor to a ceiling. The enclosure essentially walls off and contains debris and contaminants generated during construction. Further, a worker may use such an enclosure to carry out construction work on the ceiling or above the ceiling, while the space below needs to remain debris and contaminant free. However, fixing the enclosure to the floor and ceiling, while functional, is less than ideal in that the enclosure may not be moved or relocated.

Conventional mobile enclosures allow movement and relocation of the enclosure, but commonly requires the worker to place and use a step ladder within the enclosure as a way of providing access to the ceiling. This can also be less than ideal, problematic, and even dangerous. For example, placing the step ladder within the mobile enclosure is awkward and falling from the ladder or puncturing the enclosure when placing, setting up, or moving the ladder may be potentially dangerous and defeat the entire purpose of the contaminant enclosure. Additionally, when a ceiling is relatively high, a step ladder needed to reach the ceiling height may present an undesirably large physical footprint within the enclosure as the ladder is deployed, which may put a costly and physically untenable requirement on the size of the enclosure (e.g., when attempting to work in areas where structure outside the enclosure confines the available footprint for any enclosure). Furthermore, working atop a step ladder within a confining enclosure may become dangerous for the worker when the ceiling is high, and especially when the physical footprint that supports the ladder is uneven.

A ceiling grid may also present an obstacle to the worker in a conventional enclosure who needs to gain access to the area above the ceiling grid to perform construction or other repair/service tasks. Other similar obstacles may include a building utility component above the ceiling grid (such as pipes, conduit, ducts, air handlers), or a building structural component above the ceiling grid (such as a wall, beam, or girder). These types of obstructions present access problems for a worker operating within such a conventional enclosure.

Thus, there remains a need for an improved enclosure that facilitates working above a ceiling grid while maintaining a working space within that helps avoid contaminating the space outside the enclosure with contaminants.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

One aspect of the disclosure relates to an articulating enclosed lift assembly. In this aspect, the assembly generally includes an adjustable work platform and a flexible enclosure. The adjustable work platform further includes a moveable base, a lift, an operator platform, and at least one guardrail. The lift has at least a top portion and a bottom portion where the bottom portion is operative to selectively move the operator platform to a desired position. The guardrail is coupled to the operator platform, and substantially establishes a safety zone on the operator platform.

The flexible enclosure further includes an extendible frame and a flexible enclosure material. The extendible frame has at least a top portion, a bottom portion, and a plurality of side portions. The bottom portion of the extendible frame is attached to the movable base of the adjustable work platform. And the top portion further comprises a movable top frame defining a top opening in the extendible frame. The flexible enclosure material is attached to the side portions of the extendible frame while being sealed to the operator platform near the bottom portion of the extendible frame and sealed to the movable top frame.

As such, the flexible enclosure and the movable base may define a working space below a ceiling once at least the movable top frame of the flexible enclosure extends to engage the ceiling. As the extendible frame engages the ceiling at the moveable top frame, the operator platform of the adjustable work platform may be selectively moved within the flexible enclosure as engaged to the ceiling.

In another aspect, an articulating enclosed lift assembly is described. In this aspect, the assembly generally includes an adjustable work platform, a guardrail system, and a flexible enclosure. In more detail, the adjustable work platform comprises a base, a power-driven lift coupled to the base, and an operator platform disposed on the lift. The guardrail system is coupled to the operator platform and defines a plurality of boundaries that substantially establishes a safety zone on the operator platform. The flexible enclosure comprises an extendible frame and a flexible containment material, where the flexible containment material includes at least one re-sealable access panel. The flexible containment material is disposed proximate to sides of the extendible frame (e.g., connected to one or more sides of the extendible frame, laid along the exterior of the extendible frame, placed within the extendible frame). The material is also sealed to the base of the adjustable work platform as well as along a top edge of the extendible frame.

As such, the flexible enclosure and the base define a working space below a ceiling as the top edge of the extendible frame engages an opening in the ceiling. And the operator platform of the adjustable work platform is selectively movable by the power-driven lift to place the operator platform in a desired vertical position within the flexible enclosure and allow at least a portion of the guardrail system to extend through the opening.

In a further aspect, another example of an articulating enclosed lift assembly is described. In this further aspect, the assembly generally includes an adjustable work platform, a guardrail system, and a flexible enclosure. In more detail, the adjustable work platform further comprises a base, a power-driven lift coupled to the base, and an operator platform disposed on the lift.

The guardrail system is coupled to the operator platform and includes at least a plurality of guardrail system posts and a plurality of guardrail system rails. Each of the posts are coupled to the operator platform, and at least one of the posts is retractable from an initial configuration to a retracted configuration. The rails are disposed between at least a majority of the guardrail system posts, and may include one or more rails between respectively adjacent ones of the posts (e.g., a top rail chain and a mid-rail chain). At least one of the guardrail system rails is connected to the at least one of the guardrail system posts in the initial configuration but can be disconnected from the at least one of the guardrail system posts when in the retracted configuration.

The flexible enclosure further comprises an extendible frame and a flexible containment material. The flexible containment material includes at least one access panel (such as a zip-seal type of closure on a panel to allow entry to and exit from the enclosure). As part of forming the enclosure, the flexible material is disposed about sides of the extendible frame, fixed to the base of the adjustable work platform, and attached to a top edge of the extendible frame.

As such, the flexible enclosure and the base define a working space below a ceiling as the top edge of the extendible frame engages an opening in the ceiling. Additionally, the operator platform of the adjustable work platform is selectively movable by the power-driven lift to place the operator platform in a desired vertical position within the flexible enclosure, which provides further flexible access to the working space.

In yet another aspect, a method is described for operating an articulating enclosed lift assembly comprised of at least a base, a lift mounted to the base, an operator platform mounted to the lift, an extendible frame mounted to the base, and a flexible enclosure material sealingly fixed to the base and to a top part of the extendible frame. In this aspect, the method begins by selectively extending the top part of the extendible frame from a disengaged position relative to an opening in a ceiling. Next, the method continues by engaging the top part of the extendible frame relative to the opening in the ceiling in a sealed position. This establishes a working space bounded by the base and the flexible enclosure material sealingly fixed to the base and in the sealed position engaging the opening in the ceiling. Thereafter, the method continues by selectively moving the operator platform with the lift within the working space to a desired vertical position.

Additional advantages of this and other aspects of the disclosed embodiments and examples will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments according to one or more principles of the invention and together with the description, serve to explain one or more principles of the invention. In the drawings,

FIG. 1 is an isometric view of an exemplary articulating enclosed lift assembly in accordance with an embodiment of the invention;

FIG. 2A is a side view of an interior of an exemplary articulating enclosed lift assembly in accordance with an embodiment of the invention;

FIG. 2B is a cut-away end view of an exemplary articulating enclosed lift assembly in accordance with an embodiment of the invention;

FIG. 2C is a cut-away end view of an exemplary articulating enclosed lift assembly in accordance with another embodiment of the invention;

FIG. 3A is an isometric view of an exemplary guardrail system disposed on an operator platform in an exemplary initial configuration in accordance with an embodiment of the invention;

FIG. 3B is an isometric view of an exemplary guardrail system disposed on an operator platform in an exemplary retracted configuration in accordance with an embodiment of the invention; and

FIGS. 4A-4C are collectively a series of diagrams illustrating operative stages for deploying an exemplary articulating enclosed lift assembly relative to a ceiling in accordance with an embodiment of the invention.

### DESCRIPTION OF THE EMBODIMENTS

Reference will now be made in detail to exemplary embodiments. Wherever possible, the same reference numbers are used in the drawings and the description to refer to the same or like parts.

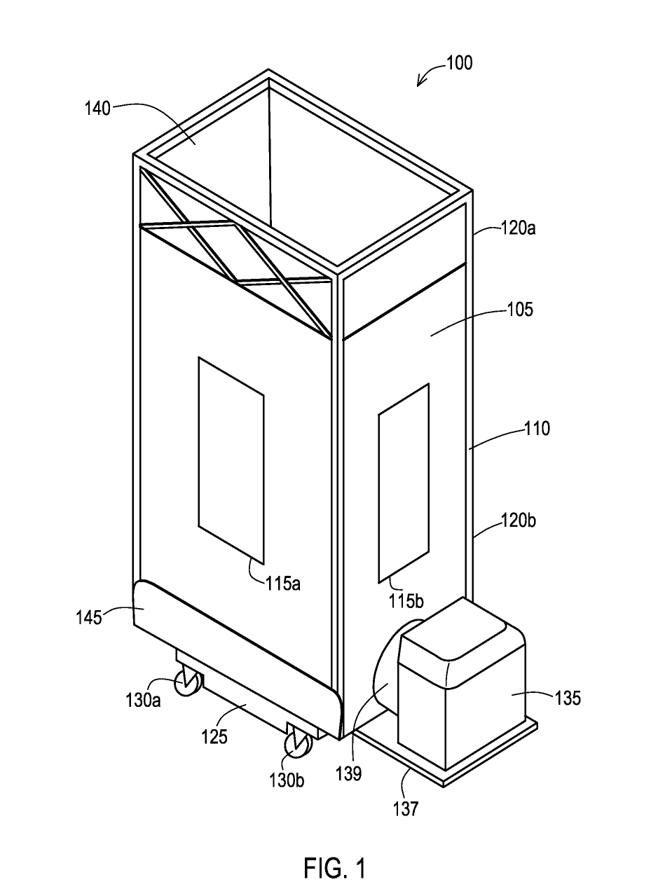

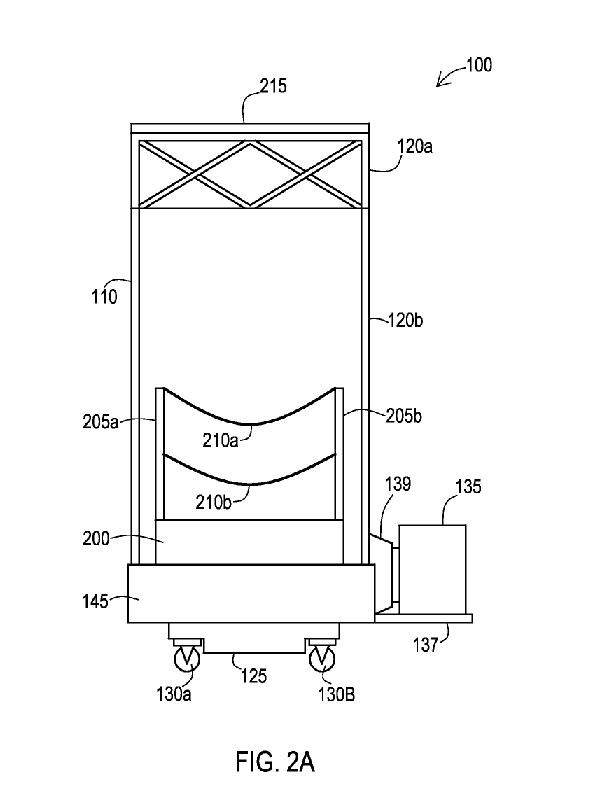

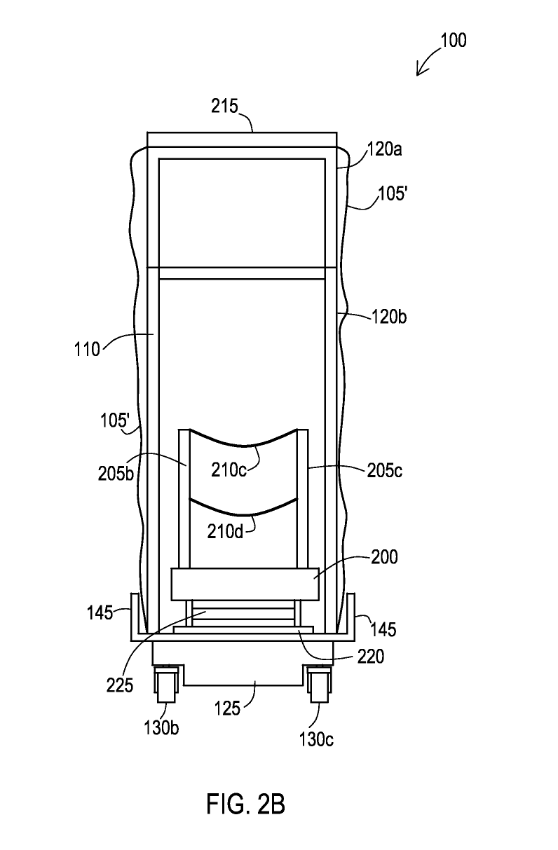

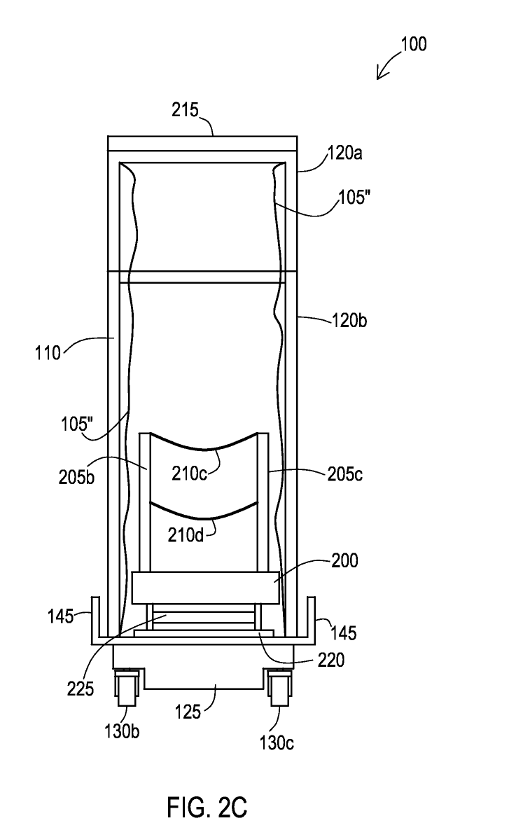

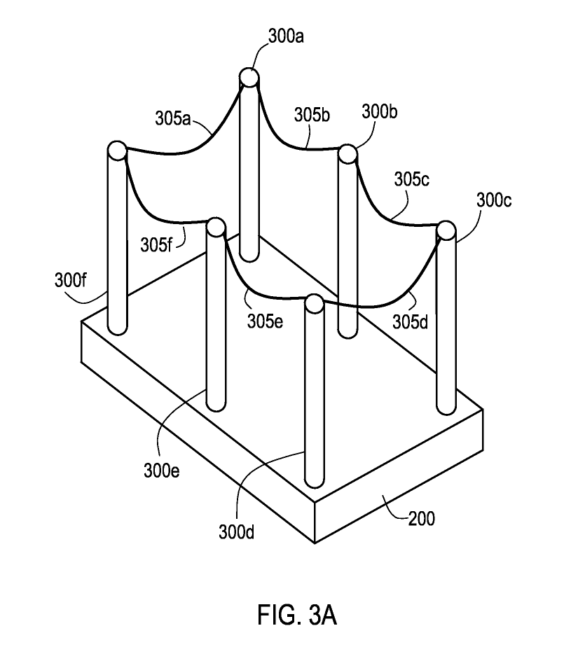

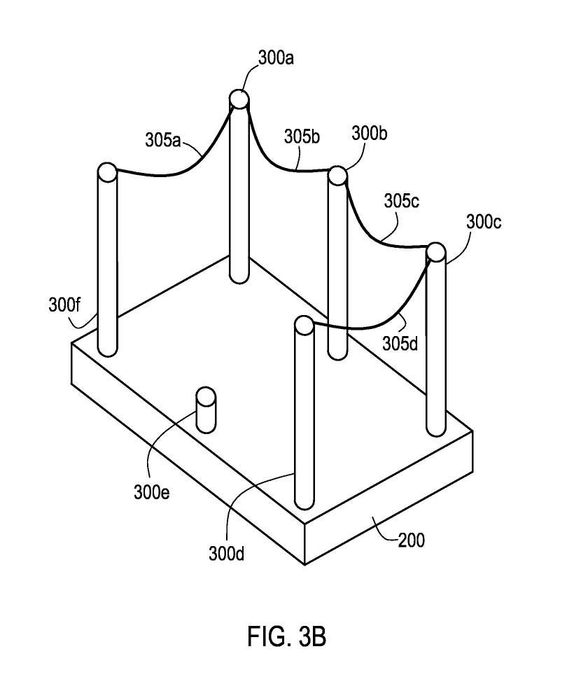

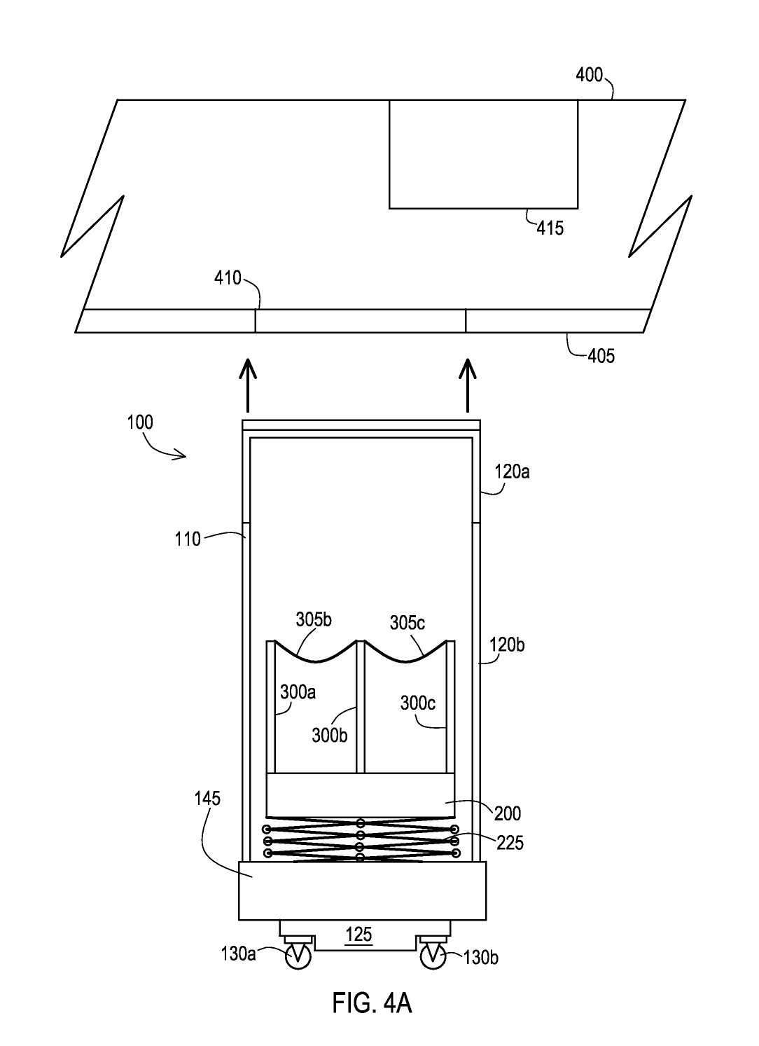

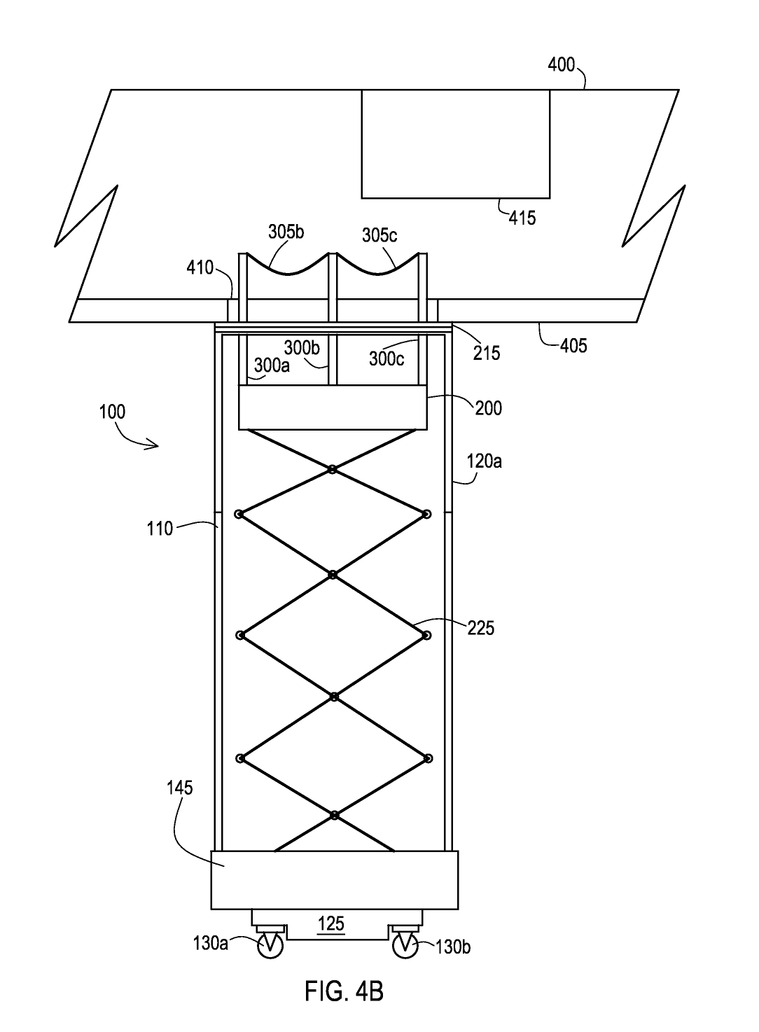

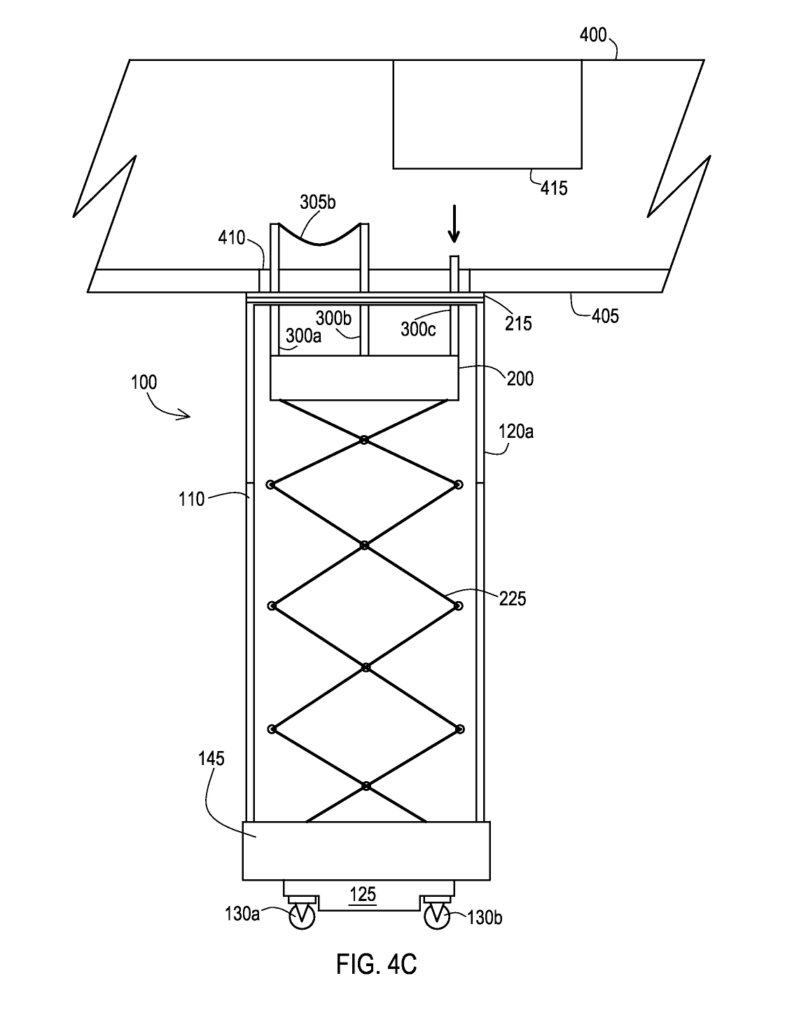

In summary, the following describes various embodiments of an articulating enclosed lift assembly as set forth herein. FIGS. 1 and 2A-2C illustrate various exterior and interior views of components making up an exemplary articulating enclosed lift assembly. FIGS. 3A and 3B illustrate how components of an exemplary guardrail system on an operator platform used on an exemplary articulating enclosed lift assembly may be dynamically reconfigured to avoid various obstacles overhead as the assembly engages a ceiling and the operator platform is lifted up. And, FIGS. 4A-4C show such an exemplary articulating enclosed lift assembly at different operative stages where different components of the assembly are moved, extended, adjusted, or otherwise articulated as part of an operational deployment of the exemplary assembly.

Referring now to the embodiment illustrated in FIG. 1, an exterior view of an exemplary articulating enclosed lift assembly 100 is shown having a movable base 125. An embodiment of the movable base 125 may be moved by hand with free-wheeling but lockable caster type wheels 130a, 130b. In another embodiment, movable base 125 may be moved via an onboard electric motor (not shown), batteries (not shown), and a control mechanism—such as a wired hand control, a remote wireless control, or a control panel disposed on or above the movable base 125 (e.g., on other components mounted on base 125). As such, a worker may move exemplary articulating enclosed lift assembly 100 to a desired location beneath a ceiling.

On top of and coupled to movable base 125, exemplary articulating enclosed lift assembly 100 further includes an exemplary flexible enclosure, generally including a flexible containment material 105 and a related extendible frame 110 disposed near and supporting the material 105. In an embodiment, the flexible containment material 105 may be a flame-retardant material, such as a treated canvas or other fire-resistant or fire-retardant woven or non-woven material.

In another embodiment, the flexible containment material 105 may include one or more re-closable or re-sealable access panels 115a, 115b. For example, access panel 115a may use a zipper seal that allows a worker to create an opening through the flexible containment material 105 so the worker may enter and exit the working space within the flexible enclosure, and provides easier access when the worker needs to bring in tools or other equipment into the working space. Once inside, the worker may then close or substantially seal the access panel 115 such that undesired particle contaminants remain contained within the working space within the flexible enclosure. In a further embodiment, one or more of the access panels 115a, 115b (and other access panels that may be disposed as part of material 105 on other sides not shown in FIG. 1) may be equipped with clear windows for enhanced visibility into and out of the flexible enclosure.

In general, the flexible containment material 105 is supported and held in place by the structural parts of extendible frame 110. For example, in an embodiment, the flexible containment material 105 may be disposed about sides of the extendible frame 110, fixed to the movable base 125 (or in some embodiments fixed to an operator platform, such as platform 200 shown in FIG. 2A), and attached to a top edge of the extendible frame 110. In other words, different embodiments may include the flexible containment material 105 outside of extendible frame 110 (such as that shown in FIG. 3A) while other embodiments may include the flexible containment material 105 inside of extendible frame 110 (such as that shown in FIG. 3B).

Still another embodiment may deploy the extendible frame 110 such that the flexible containment material 105 is deployed both inside and outside of points of extendible frame 110. For example, the flexible containment material 105 may be specially constructed with channels or pockets through which a structural part of the extendible frame 110 may be disposed. Maintaining such parts of extendible frame 110 within channels or pockets in the flexible containment material 105 (e.g., material 105 defining such channels or pockets being on both the inside and outside of parts of the extendible frame 110) may provide further confined support for holding the flexible containment material 105 close to the extendible frame 110. In more detail, one example may have part of the extendible frame 110 have material 105 fixed to and surrounding the part of the frame 110 (e.g., via a VELCRO® brand hook and loop type of fastener or other type of snap connection), while another example may have the part of the frame 110 being more loosely connected to the part of the frame (e.g., via a channel through which the part may slide and move up and down, but provide constraints for moving the material left and right).

In general, an exemplary extendible frame (such as frame 110) is a type of structural frame that helps to keep the flexible containment material in a desired but selectively changeable configuration via extension of the frame. In more detail, an embodiment of an exemplary extendible frame may at least have a top portion, a bottom portion, and a plurality of side portions. The top portion (e.g., top frame portion 120a of frame 110) may move or be otherwise extended relative to other portions of the frame (such as a bottom portion (not shown) of the extendible frame 110 horizontally attached to the movable base 125 or separate vertical side portions 120b of frame 110 disposed between the top portion 120a and the bottom horizontal portion or a support base for the frame 110 (such as operator platform 200)). In one embodiment, the frame 110 may not include bottom horizontal structure and simply is deployed with side vertical portions 120b and a top frame portion 120a, which may be extended.

The top portion of the extendible frame (e.g., the top frame portion 120a of frame 110 or, more specifically, a top edge of top frame portion 120a) defines a top opening 140 in the extendible frame 110. As such, a worker within the flexible enclosure of exemplary articulating enclosed lift assembly 100 may have access to the ceiling or above the ceiling through opening 140 once the extendible frame 110 has been extended to mate and engage with the ceiling (as shown in more detail in the examples of FIGS. 4A-4C below).

Likewise, an embodiment may retract the extendible frame 110 to a desired low height configuration of the frame 110 where the exemplary articulating enclosed lift assembly 100 presents a relative small height profile. For example, an embodiment may retract extendible frame 110 in order to enable the articulating enclosed lift assembly 100 to more conveniently move through a conventional door (as opposed to a conventional rigid enclosure that may not be height adjustable and requiring tipping over the rigid enclosure in an awkward and disruptive way (e.g., tools within the enclosure would not stay where initially placed)).

Those skilled in the art will appreciate that a variety of mechanisms may be used to extend the frame 110 upwards towards a ceiling. For example, the top portion 120a and the side portion 120b may be in a telescopic configuration and manually extended (e.g., uncoupled, extended, re-coupled or fixed again to each other), or may be selectively extended via controlled action of a motor, gear, or hydraulic pressure relative to the top portion 120a. And as the frame 110 (e.g., the top frame portion 120a of frame 110 or, alternatively, just a top edge of top frame portion 120a) extends upwards towards the ceiling, an embodiment will have enough flexible containment material 105 such that the flexible enclosure is able to adapt to different ceiling heights up to a maximum height of the frame 110 as extended.

Additionally, FIG. 1 illustrates a fan and filter unit 135 disposed on a fan/filter base extension 137 coupled to movable base 125. The fan and filter unit 135 is operatively coupled to the working space within the flexible enclosure via a duct 139. In one embodiment, fan and filter unit 135 may be implemented with a HEPA vacuum and used to vacuum and filter debris and particulates and any potential contaminants to avoid allowing them into the space outside of the flexible enclosure.

FIG. 2A is a side view of an interior of exemplary articulating enclosed lift assembly 100. In FIG. 2A, exemplary articulating enclosed lift assembly 100 is illustrated prior to installing or simply without flexible containment material 105 for purposes of explaining the features deployed in the interior of an exemplary embodiment of articulating enclosed lift assembly 100. Those skilled in the art will recognize that assembly 100 has flexible containment material 105 deployed when such an embodiment of the articulating enclosed lift assembly 100 is used by a worker.

Referring now to FIG. 2A, exemplary articulating enclosed lift assembly 100 is further shown as having an adjustable work platform disposed within the flexible enclosure outlined by extendible frame 110. The exemplary adjustable work platform includes various elements built on movable base 125 that allow a worker to be selectively elevated to a desired position within the flexible enclosure of the frame 110 and material 105 and, in some case, above the flexible enclosure.

In particular, an exemplary operator platform 200 is illustrated within the extendible frame 110. The exemplary operator platform 200 may be selectively moved relative to movable base 125 so that the operator platform 200 may be raised or lowered independent of how extendible frame 110 may be extended up towards a ceiling or retracted back down.

As shown in FIG. 2A, an exemplary guardrail system of posts 205a, 205b and rails 210a, 210b is coupled to the operator platform 200. Such a guardrail system provides structure that effectively and substantially establishes a safety zone on the operator platform 200 to help ensure the safety of a worker within the working space within exemplary articulating enclosed lift assembly 100. As will be explained below in more detail with reference to FIGS. 3A and 3B, the guardrail systems posts 205a, 205b may be implemented to retract, compress, or otherwise move so that obstacles may be avoided when manipulating the height of the operator platform 200. In another embodiment, the guardrail system rails 210a, 210b may be temporarily detached or removed. The ability to reconfigure the guardrail system as the operator platform 200 approaches the ceiling, allows an embodiment to provide working access above the ceiling while avoiding obstacles and obstructions that may be present from the ceiling, the ceiling grid, and structure above the ceiling grid. Thereafter, the safety zone may be re-established. In one embodiment, when the obstruction is no longer present or otherwise interfering with reconnecting parts of the guardrail system, the safety zone is re-established by changing the configuration of parts of the guardrail system back to a configuration associated with a safety zone (e.g, replacing parts previously removed or placing parts back into an initial configuration associated with the safety zone). In another embodiment, to the extent an obstruction above the ceiling remains interfering with reconnecting parts of the guardrail system, the obstruction itself (as placed proximate to other parts of the guardrail system) may effectively function to fill the void by the detached or disconnected part of the guardrail system.

For example, a guardrail system rail 210 a (e.g., one or more flexible chains between posts, one or more detachable rods between posts, or a flexible netting strung between posts) may be temporarily removed as the operator platform 200 is raised and the posts 205a, 205b begin to go through the ceiling grid. Once above the grid, to the extent possible or desirable (such as when using a chain as a guardrail system rail 210a), the removed rail 210a may be re-attached to the respective post or posts (e.g., posts 205a and/or 205b) as part of re-establishing a safety zone while avoiding obstacles and working above the ceiling grid.

In an embodiment, the guardrail system rail may include multiple flexible chains disposed between adjacent posts so that there is a top rail chain, as well as further chain rails below the top rail chain. In such an example, the top rail chain may first be removed as the operator platform 200 is raised given that a structural support of the ceiling grid may be interfering with the top rail chain. As the operator platform 200 is further raised, the top rail chain may be re-attached, which causes the safety zone established with the initial configuration of guardrail system parts to be re-established. And as the operator platform 200 is raised even further, a mid-rail chain may be removed given the mid-rail chain is disposed between posts and below the re-attached top chain rail. Then, as the operator platform 200 is raised even further, the mid-rail chain rail is re-attached, which again causes the safety zone to be re-established.

FIG. 2A also shows a seal 215 disposed along the periphery of the top opening 140 and at the top edge of the top portion 120a of the extendible frame 110. In an embodiment, the seal 215 is a foam-like gasket type of structure fixed to the top edge of the top portion 120a. The seal 215 allows for more effectively engaging or mating with a bottom surface of a ceiling, typically around an opening in the ceiling. An embodiment of seal 215 may have a flat top surface, but alternatively may have a stepped or shaped cross-sectional profile such that seal 215 provides more sealing material along an edge closest to opening 140. This may allow for better engagement with a conventionally-sized opening in the ceiling (e.g., a standard ceiling tile opening size in a ceiling grid). Thus, as the top portion 120 is extended towards the ceiling, an embodiment of seal 215 engages and effectively seals the working space within the extendible frame 110 and flexible containment materials 105 with that of the space above the ceiling.

FIGS. 2B and 2C provide further details of an exemplary adjustable work platform as part of exemplary articulating enclosed lift assembly 100. In particular, FIG. 2B is a cut-away end view of exemplary articulating enclosed lift assembly 100 in accordance with an embodiment of the invention. Referring now to FIG. 2B, movable base 125 may have a base tray 220 with side flanges 145 mounted to the base 125. Exemplary side flanges 145 are disposed outside of the bottom and side parts of the extendible frame 110 and may operate to gather loose parts of the bottom of flexible containment material 105′ prior to extending top portion 120a of the frame 110. Other embodiments may not include a base tray 220 with structure that helps gather and collect material 105′ as frame 110 is retracted.

Operator platform 200 can now be seen in FIG. 2B as being disposed on an exemplary lift 225. In an embodiment, the operator platform 200 may be bolted or otherwise coupled to a top portion of the lift 225 while a bottom portion of the lift 225 may be fixed or otherwise coupled to movable base 125 (or structure associated with the base 125, such as base tray 220). The exemplary lift 225 is operative to selectively move the operator platform 200 to a desired position within the flexible enclosure of frame 110 and material 105′. In a more detailed embodiment, the exemplary lift 225 may be implemented with a power-driven lift (e.g., a telescoping ram lift where pneumatic pressure provides a lifting force, a scissors-type driven lift that articulates scissoring elements to generate the lifting force, and a gear-driven lift (such as a worm screw jack type of device) that relies upon rotating belts, chain, gears, and/or shafts to transfer energy and provide an appropriate lifting force). In a further embodiment, such an exemplary lift 225 may be implemented with a combination of different types of lifts depending on the size and weight of the operator platform 200 and the degree of lifting control desired (e.g., a first type of lift for coarse vertical lift adjustment (telescoping) and a second type of lift for finer vertical lift adjustment (scissors)).

Those skilled in the art will understand that the exemplary flexible containment material and extendible frame may have various different configurations while still providing a flexible enclosure in an embodiment. Generally, the flexible enclosure material, such as material 105, may simply be fixed and sealed to the base 125 and to a top part of the extendible frame 110. As such, material 105 may not necessarily be attached to any side structure of the frame 110, but only sealed to the base 125 and to the extending top part of frame 110.

In another embodiment, the flexible containment material may be disposed proximate to sides of the extendible frame 110 and sealed to the base 125 of the adjustable work platform and along a top edge of the top portion 120a of the extendible frame 110. In such an embodiment, the material may be outside the frame 110 (e.g., material 105′ shown in FIG. 2B) or may be inside the frame 110 (e.g., material 105″ shown in FIG. 2C).

In yet another embodiment, the flexible enclosure's containment material may be attached to the side portions 120b of the extendible frame while being sealed to the operator platform 200 near the bottom of the extendible frame 110 (rather than the base) and sealed to the movable top frame 120a. In this embodiment, duct 139 may be a flexible hose to allow for movement of the operator platform 200 while maintaining an operative connection between the fan and filter unit 135 and the flexible enclosure's containment material.

In still a further embodiment, the flexible containment material may be disposed about sides of the extendible frame 110, fixed to the base 125 of the adjustable work platform, and attached to a top edge of the top portion 120a of the extendible frame 110. For example, as opposed to having the material 105′ being inside relative to frame 110, the material 105″ may be disposed outside the frame 110 (e.g., as shown in FIG. 2B).

FIGS. 3A and 3B provide further details of an exemplary guard rail system as part of exemplary articulating enclosed lift assembly 100. In particular, FIG. 3A is a view of an exemplary guardrail system disposed on exemplary operator platform 200 in an exemplary initial configuration in accordance with an embodiment of the invention. Referring now to FIG. 3A, an embodiment of the guardrail system is illustrated as comprising a group of posts 300a-300f coupled to operator platform 200 and rails 305a-305f disposed between such posts 300a-300f. As such, each of the exemplary rails 305a-305f are considered elements that, via the respectively connected ones of the posts 300a-300f, may be coupled to operator platform 200 (even if detachably coupled to the posts, and such posts are fixed or retractable). Generally, the posts 300a-300f and rails 305a-305f of the illustrated guardrail system of FIG. 3A define an example of multiple fixed and temporary boundaries (or in some embodiments all temporary boundaries) that substantially establish a type of safety zone on the operator platform 200.

In more detail, FIG. 3A illustrates the posts 300a-300f and rails 305a-305f of the illustrated guardrail system in an initial configuration where no posts are retracted and no rails have been moved, removed, disconnected, or detached. Typically, such an initial configuration appears once the worker has entered the flexible enclosure, removed or detached one of the rails so as to effectively access the platform 200, stepped onto the operator platform 200, and then re-attached the detachable rail or rails.

As noted above, an embodiment of a guardrail system may include more than one rail between adjacent posts—e.g., a top rail, a mid-rail, etc. The number of rails disposed between posts is a matter of design choice, but also may be chosen to be more than one to help to create and establish an enhanced and better performing safety zone within the confines of the initial configuration of connected rails to their respective posts. Likewise, different embodiments of a guardrail system may include larger or smaller numbers of posts. For example, in one embodiment, there may be four exemplary guardrail system posts, with each post being permanently fixed and attached near a corner of a rectangular-shaped operator platform. However, other embodiments may have six or more posts (such as that shown in FIGS. 3A and 3B), and one or more of the posts may not-be fixed. In other words, by using one or more selectively movable posts in an embodiment, a further type of change or alteration of the guardrail system may be possible to help deal with obstructions and obstacles presented as the operator platform is raised.

As the operator platform 200 approaches the ceiling, a worker using the exemplary articulating enclosed lift apparatus 100 may desire to have part or all of the operator platform 200 raised up to and through a ceiling grid. This may occur, in some situations, with no change from the initial configuration. However, in order to avoid an obstruction as all or part of the operator platform 200 (including posts 300a-300f and rails 305a-305f) is raised, an embodiment of the guardrail system may change to a different configuration. In particular, changing to this different configuration may be where one or more elements or boundaries making up the guardrail system may be altered (e.g., moved, detached, disconnected, compressed, or retracted) in the different configuration. For example, flexible chain rails may be incrementally moved/disconnected and then reconnected as the operator platform 200 is raised—such as when a top rail chain is removed and then reconnected before a mid-rail chain is removed and then reconnected as the platform 200 is continued to be raised. Thus, the configuration of exemplary guardrail system elements may be changed as obstacles are encountered.

FIG. 3B is a view of the exemplary guardrail system of FIG. 3A, but now altered to be in an exemplary retracted configuration in accordance with an embodiment of the invention. Referring now to the illustrated example shown in FIG. 3B, an embodiment may have operator platform 200 raised to a point where rails 305e and 305f needed to be detached or otherwise temporarily removed to allow the operator platform 200 to be raised above an interfering or obstructing ceiling grid structure. Furthermore, the example of FIG. 3B shows how a guardrail system post 300e may be implemented to vertically move, compress, or retract down. As noted above, in some embodiments, the posts are permanently fixed, but in other embodiments (such as shown in FIG. 3B), additional flexibility in changing the configuration of the guardrail system may be accomplished with selectively movable posts (e.g., posts which may stay sturdy and rigid to sufficiently operate as part of a reliable guardrail system element, but that may be selectively changed, moved, or reconfigured in order to help with avoiding obstacles). For example, exemplary post 300e may be implemented with a telescoping post where a top inner portion of the post retracts into a bottom outer potion of the telescoping post as a way to effectively draw down the height of post 300e to avoid an obstruction disposed above the platform 200 (e.g., by the ceiling itself, by a ceiling grid structure, or by some other structure disposed above the ceiling grid). Alternatively, exemplary post 300e may be implemented with a solid post that physically retracts or can be lowered into operator platform 200 to a degree. The retracting mechanism may be a motor driven or hydraulic driven actuator that causes the post to change vertical positions. Still another embodiment may have post 300e physically retracting part way into operator platform 200, and then telescoping down further in order to provide a wider range for any desired retraction. Yet another embodiment may have post 300e being temporarily removable from operator platform 200, but capable of being reattached once clear of any obstruction.

Thus, an embodiment has at least one of the guardrail system posts being retractable from an initial configuration to a retracted configuration. And another embodiment has at least one of the guardrail system rails (or at least a portion of a rail) being detachably connected to that guardrail system post(s) in the initial configuration, but capable of being disconnected from that guardrail system post(s) when in the retracted configuration.

FIGS. 4A-4C are, collectively, a series of diagrams illustrating exemplary operative stages for deploying an exemplary articulating enclosed lift assembly relative to a ceiling in accordance with an embodiment of the invention. Referring now to FIG. 4A, an upper fixed ceiling 400 is shown above a lower drop ceiling 405. As part of drop ceiling 405, those skilled in the art will appreciate that a ceiling grid (not shown) may be incorporated as part of the drop ceiling 405. In more detail, a ceiling grid may be disposed below the upper fixed ceiling 400, where multiple ceiling tiles (not shown) may be disposed within sections of the ceiling grid to form the lower drop ceiling 405. When one or more of the ceiling tiles are not in place within the ceiling grid, an opening 410 in ceiling 405 may appear. It is through such an opening 410 that construction on the upper ceiling 400 or work on building service equipment 415 above ceiling 405 but below ceiling 400 (e.g., air handlers, junction boxes, ducts, etc.) may be performed.

To better gain access to areas on the ceiling 405, ceiling 400, and anything in the space in between, an exemplary articulating lift assembly apparatus 100 may be deployed as shown in the example of FIG. 4A. In FIG. 4A, a user (such as a construction worker) may use such an exemplary articulating lift assembly apparatus 100 by selectively extending the top part of the extendible frame 110 (e.g., a movable top edge of top portion 120a) from a disengaged position relative to opening 410 in lower drop ceiling 405.

Extending the frame 110 will eventually cause the top portion 120a of the frame 110 to close in on the opening 410. When the apparatus 100 has been moved, placed correctly below the opening 410 to align the top edge with the opening 410, and the wheels 130a, 130b are locked to avoid further movement of base 125, the top portion 120a of the extendible frame 110 may complete its extension and engage the opening 410 in the ceiling 405 in a sealed position. This establishes a working space bounded by the base 125 and the flexible enclosure material 105 sealingly fixed to the base 125 and in the sealed position engaging the opening 410 in the ceiling 405.

As noted above, in an alternative embodiment, the working space may be bounded by the operator platform 200, instead of the base 125, because the flexible enclosure material 105 may sealingly be fixed to at least a top of the operator platform 200 and a top of the extendible frame 110 that sealingly engages the opening 410 in the ceiling 405.

Referring now to FIG. 4B, once the seal 215 engages the opening 410 (or whatever targeted part of the ceiling is desired that encompasses the opening 410 or prior to creating an opening in ceiling 405), the adjustable work platform (e.g., base 125, lift 225, operator platform 200, and guardrail system of posts 300a-300c and rails 305b-305c) may be articulated. In more detail, an embodiment may selectively move the operator platform 200 of the adjustable work platform within the flexible enclosure as engaged to the ceiling 405. In this manner, the operator platform 200 (and the guardrail system and onboard worker) may be selectively moved by the lift 225 within the working space to a desired vertical position.

In one embodiment, such a desired vertical position may be a position where at least a portion of the guardrail system disposed on the operator platform 200 extends up and through the opening 410 in the ceiling 405, as shown in FIG. 4B. Thus, a worker on operator platform 200 may make use of such an exemplary embodiment having an articulating enclosed lift assembly 100 to access and work in a space on or above the ceiling 405.

FIG. 4C shows an example embodiment where the configuration of the guardrail system has been changed from an initial configuration to avoid an obstacle, such as air handler unit 415 disposed between the upper ceiling 400 and the lower drop ceiling 405. As noted above with respect to FIG. 3B, the configuration of the guardrail system's rails and/or posts may be dynamically altered. Referring now to FIG. 4C, such an altered configuration may be achieved by altering, changing, moving, retracting, or otherwise detaching one or more elements or boundaries of the guardrail system (such as the rails 305b-305c and/or posts 300a-300c shown in FIG. 4C) so as to avoid an obstruction above the operator platform 200 (e.g., a part of ceiling 405, a part of a suspended ceiling grid incorporated into ceiling 405 but exposed within opening 410, and by some other structure, such as air handler unit 415, disposed above the ceiling grid).

Thus, as shown in the example of FIG. 4C, the operator platform 200 may be raised with the lift 225 to a first vertical position, such as an intermediate vertical stop where the necessary parts of the guardrail system that need to be reconfigured due to an obstacle or obstruction (e.g., rails that are detached, moved, or unchained; and/or posts that may be moved, lowered, compressed, or retracted) are identified. Then a configuration of the guardrail system may be appropriately changed, based on the identified parts of the guardrail system, to avoid the obstacle or obstruction disposed above the operator platform 200.

In a more detailed embodiment, changing the configuration may involve removing at least one flexible rail (e.g., one or more chains) of the guardrail system to avoid the obstruction disposed above the operator platform 200 as the operator platform 200 is selectively moved to the desired vertical position. In another embodiment, changing the configuration may involve retracting at least one post of the guardrail system to avoid the obstruction disposed above the operator platform 200 as the operator platform 200 is selectively moved to the desired vertical position. As shown in FIG. 4C, rail 305c has been detached from posts 300b and 300c, and post 300c has been retracted in order to avoid the obstacle or obstruction presented by air handler unit 415 as operator platform 200 is raised to a position that allows a worker to more easily work on air handler unit 415 from the platform 200 while still maintaining a degree of safety zone from the retracted configuration of the guardrail system.

At least some portions of exemplary embodiments outlined above may be used in association with portions of other exemplary embodiments. Moreover, at least some of the exemplary embodiments disclosed herein may be used independently from one another and/or in combination with one another and may have applications to apparatus and method of operating the apparatus not disclosed herein.

It will be apparent to those skilled in the art that various modifications and variations can be made to the structures and operational methodologies described herein. Thus, it should be understood that the invention is not limited to the exemplary subject matter discussed in the description. Rather, the present invention is intended to cover modifications and variations.

What is claimed is:

1. An articulating enclosed lift assembly, comprising:
an adjustable work platform comprising,
a movable base,
a lift comprising at least a top portion and a bottom portion, wherein the bottom portion of the lift is coupled to the movable base,
an operator platform coupled to the top portion of the lift, wherein the lift is operative to selectively move the operator platform to a desired position, and
at least one guardrail coupled to the operator platform, wherein the guardrail substantially establishes a safety zone on the operator platform; and
a flexible enclosure comprising,
an extendible frame comprising at least a top portion, a bottom portion, and a plurality of side portions, wherein the bottom portion of the extendible frame is attached to the movable base of the adjustable work platform, and wherein the top portion further comprises a movable top frame defining a top opening in the extendible frame, and
a flexible enclosure material attached to the side portions of the extendible frame while being sealed to the operator platform near the bottom portion of the extendible frame and sealed to the movable top frame;
wherein the flexible enclosure and the movable base define a working space below a ceiling once at least the movable top frame of the flexible enclosure extends to engage the ceiling; and
wherein the extendible frame engages the ceiling at the moveable top frame, and wherein the operator platform of the adjustable work platform is selectively movable within the flexible enclosure as engaged to the ceiling.

2. The articulating enclosed lift assembly of claim 1, wherein the lift comprises at least one from a group consisting of a telescoping ram lift, a scissors-driven lift, and a gear-driven lift.

3. The articulating enclosed lift assembly of claim 1, wherein the lift comprises:
a first lift operative to provide a coarse vertical lift movement of the operator platform; and
a second lift operative to provide a finer vertical lift movement of the operator platform.

4. The articulating enclosed lift assembly of claim 1 further comprising a seal attached to the moveable top frame and for engaging an opening in the ceiling as the extendible frame extends to engage the ceiling.

5. The articulating enclosed lift assembly of claim 1, wherein at least a portion of the adjustable work platform is operative to be moved above the ceiling.

6. The articulating enclosed lift assembly of claim 5, wherein a portion of the guardrail is movable to avoid a first obstruction disposed above the ceiling or a second obstruction defined by a part of the ceiling.

7. The articulating enclosed lift assembly of claim 5, wherein the guardrail further comprises a plurality of guardrail system posts and a plurality of guardrail system rails coupled to the guardrail system posts.

8. The articulating enclosed lift assembly of claim 7, wherein at least one of the guardrail system rails is detachable as coupled to a respective one of the guardrail system posts to avoid an obstruction defined by a part of the ceiling.

9. The articulating enclosed lift assembly of claim 6, wherein at least one of the guardrail system posts is vertically movable with respect to the operating platform to avoid an obstruction disposed above the ceiling.

10. An articulating enclosed lift assembly, comprising:
an adjustable work platform comprising a base, a power-driven lift coupled to the base, and an operator platform disposed on the lift; and
a guardrail system coupled to the operator platform, the guardrail system defining a plurality of boundaries that substantially establishes a safety zone on the operator platform; and
a flexible enclosure comprising an extendible frame and a flexible containment material, wherein the flexible containment material includes at least one re-sealable access panel, the flexible containment material being disposed proximate to sides of the extendible frame and sealed to the base of the adjustable work platform and along a top edge of the extendible frame; and
wherein the flexible enclosure and the base define a working space below a ceiling as the top edge of the extendible frame engages an opening in the ceiling,
wherein the operator platform of the adjustable work platform is selectively movable by the power-driven lift to place the operator platform in a desired vertical position within the flexible enclosure and allow at least a portion of the guardrail system to extend through the opening.

11. The articulating enclosed lift assembly of claim 10, wherein the top edge further comprises a seal for engaging the opening in the ceiling.

12. The articulating enclosed lift assembly of claim 10, wherein an initial configuration of at least one of the plurality of boundaries is operative to be altered to avoid an obstruction disposed above the operator platform.

13. The articulating enclosed lift assembly of claim 12, wherein the obstruction is at least one from a group comprising a ceiling grid, a building utility component above the ceiling grid, and a building structural component above the ceiling grid.

14. An articulating enclosed lift assembly, comprising:
an adjustable work platform comprising a base, a power-driven lift coupled to the base, and an operator platform disposed on the lift; and
a guardrail system coupled to the operator platform, the guardrail system further comprising,
a plurality of guardrail system posts, wherein each of the guardrail system posts are coupled to the operator platform, wherein at least one of the guardrail system posts is retractable from an initial configuration to a retracted configuration,
a plurality of guardrail system rails disposed between at least a majority of the guardrail system posts, wherein at least one of the guardrail system rails is connected to the at least one of the guardrail system posts in the initial configuration but can be disconnected from the at least one of the guardrail system posts when in the retracted configuration; and
a flexible enclosure comprising an extendible frame and a flexible containment material, wherein the flexible containment material includes at least one access panel and is disposed about sides of the extendible frame, fixed to the base of the adjustable work platform, and attached to a top edge of the extendible frame; and
wherein the flexible enclosure and the base define a working space below a ceiling as the top edge of the extendible frame engages an opening in the ceiling,
wherein the operator platform of the adjustable work platform is selectively movable by the power-driven lift to place the operator platform in a desired vertical position within the flexible enclosure.

15. The articulating enclosed lift assembly of claim 14, wherein at least one from the retractable one of the guardrail system posts and the flexibly connected guardrail system rails are moved to avoid an obstruction disposed above the operator platform.

16. The articulating enclosed lift assembly of claim 15, wherein the obstruction is at least one from a group comprising a ceiling grid, a building utility component above the ceiling grid, and a building structural component above the ceiling grid.

17. A method of operating an articulating enclosed lift assembly comprising a base, a lift mounted to the base, an operator platform mounted to the lift, an extendible frame mounted to the base, and a flexible enclosure material sealingly fixed to the base and to a top part of the extendible frame, the method comprising the steps of:
selectively extending the top part of the extendible frame from a disengaged position relative to an opening in a ceiling;
engaging the top part of the extendible frame relative to the opening in the ceiling in a sealed position that establishes a working space bounded by the base and the flexible enclosure material sealingly fixed to the base and in the sealed position engaging the opening in the ceiling; and
selectively moving the operator platform with the lift within the working space to a desired vertical position.

18. The method of claim 17, wherein the desired vertical position allows at least a portion of a guardrail system disposed on the operator platform to extend up and through the opening in the ceiling.

19. The method of claim 18, wherein the selective moving step further comprises
raising the operator platform with the lift to a first vertical position; and
changing a configuration of the guardrail system to avoid an obstruction disposed above the operator platform.

20. The method of claim 19, wherein the step of changing the configuration of the guardrail system to avoid the obstruction disposed above the operator platform further comprises removing at least one flexible rail of the guardrail system to avoid the obstruction disposed above the operator platform as the operator platform is selectively moved to the desired vertical position.

21. The method of claim 19, wherein the step of changing the configuration of the guardrail system to avoid the obstruction disposed above the operator platform further comprises retracting at least one post of the guardrail system to avoid the obstruction disposed above the operator platform as the operator platform is selectively moved to the desired vertical position.

22. The method of claim 17, wherein the engaging step comprises engaging the top part of the extendible frame relative to the opening in the ceiling in the sealed position to establish a working space bounded by the operator platform and the flexible enclosure material sealingly fixed to the operator platform and a top of the extendible frame that sealingly engages the opening in the ceiling.
